(19) United States
(12) Patent Application Publication
(10) Pub. No.: US 2004/0017337 A1
(43) Pub. Date: Jan. 29, 2004

(54) Adjustment device for light source of a panel

(75) Inventor: Chiang-Hung Lin, Taipei Hsien (TW)

Correspondence Address: BACON & THOMAS, PLLC, 625 SLATERS LANE, FOURTH FLOOR, ALEXANDRIA, VA, 22314

(73) Assignee: Kinpo Electronics, Inc., Taipei (TW)

(21) Appl. No.: 10/200,743

(22) Filed: Jul. 24, 2002

(51) Int. Cl. G09G 3/36

(52) U.S. Cl. 345/87

(57) ABSTRACT

Adjustment device for light source of a panel, including a photosensitive resistor inlaid in the surface of the housing of a digital product for detecting the intensity of the light beam of ambient environment and changing the resistance. After the photosensitive resistor is serially connected with a resistor, via a voltage dividing point therebetween, the photosensitive resistor is connected to an A/D converter for detecting the variation of the resistance of the photosensitive resistor. The output of the A/D converter is connected to a CPU. The CPU controls a liquid crystal back light circuit to change the illumination of the back light or front light in accordance with the intensity of the light beam of ambient environment. Therefore, a power-saving effect and an eye-protective effect can be achieved.

### BACKGROUND OF THE INVENTION

The present invention is related to an adjustment device for light source of a panel, which is able to change the illumination of the back light or front light in accordance with the change of illumination of ambient environment. Therefore, a power-saving effect and an eye-protective effect can be achieved.

It is a trend to minify various digital products such as notebook-type computer and personal digital assistant (PDA) for easy carriage. However, the using time of the power supply of such mini-type products is quite limited. Therefore, it is tried by the manufacturers to develop light and power-saving digital products for convenient use.

Liquid crystal display (LCD) consumes low power, generates little heat and has a suitable volume. Therefore, LCD has been widely applied to various fine digital products such as the PDA and notebook-type computer. In LCD, a liquid crystal panel serves to refract or isolate light beam for displaying different images. Therefore, in LCD, a back light or front light structure with a fixed brightness serves as a light source to aid the liquid crystal panel in displaying the images. In the current products, the illumination of the light source can be manually adjusted by a user. However, this is inconvenient for the user so that the user is often disinclined to perform such adjustment. With the fixed or manually adjustable the back light or front light structure, no matter whether the environment is bright (necessitating lower back light or front light illumination) or dark (necessitating higher back light or front light illumination), the back light or front light structure always provides fixed brightness and consume power at fixed rate. This is not economic.

Moreover, with the back light or front light having fixed brightness, in the case of a dark place, the illumination of the back light or front light will be glary. After a long period of use, a user's eyes may get hurt.

### SUMMARY OF THE INVENTION

It is therefore a primary object of the present invention to provide an adjustment device for light source of a panel, including a photosensitive resistor inlaid in the surface of the housing of a digital product for detecting the intensity of the light beam of ambient environment and changing the resistance. The photosensitive resistor is connected to an A/D converter. The output of the A/D converter is connected to a CPU. The CPU controls a liquid crystal back light circuit to change the illumination of the back light or front light in accordance with the intensity of the light beam of ambient environment. Therefore, a power-saving effect is achieved.

It is a further object of the present invention to provide the above adjustment device which is able to change the illumination of the back light or front light of the liquid crystal panel in accordance with the brightness of ambient environment. Therefore, the illumination of the display panel will not be insufficient or too strong and glary to see.

The present invention can be best understood through the following description and accompanying drawings wherein:

### BRIEF DESCRIPTION OF THE DRAWINGS

FIG. 1 is a block circuit diagram of the present invention; and

FIG. 2 is a plane view of an embodiment of the present invention.

### DETAILED DESCRIPTION OF THE PREFERRED EMBODIMENTS

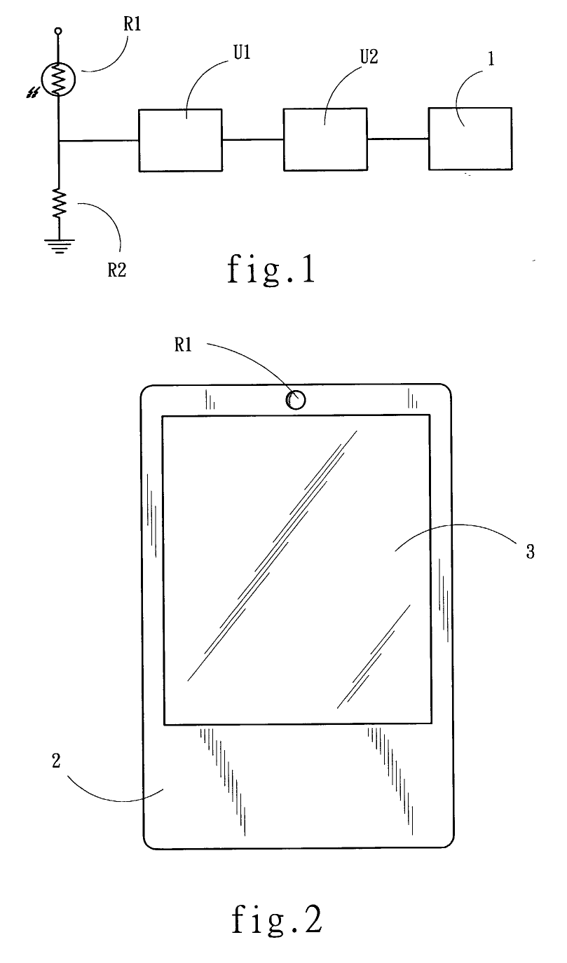

Please refer to FIGS. 1 and 2. The present invention is applicable to a PDA. A photosensitive resistor R1 is inlaid in the surface of the housing 2 on the same side as the liquid crystal panel 3. The photosensitive resistor R1 serves to detect the intensity of the light beam of ambient environment (as shown in FIG. 2). After the photosensitive resistor R1 is serially connected with a resistor R2, via a voltage dividing point therebetween, the photosensitive resistor R1 is connected to an A/D converter U1. The output of the A/D converter U1 via a CPU U2 is connected to a liquid crystal back light circuit 1.

In use, a VCC is applied to the photosensitive resistor R1 (and the resistor R2 is grounded). The photosensitive resistor R1 detects the intensity of the light beam of ambient environment and changes the resistance. Accordingly, the resistor R2 (that is, the point output to A/D converter U1) forms different divided voltages. The A/D converter U1 outputs signals to the CPU U2. An inbuilt operation system of the CPU U2 controls the liquid crystal back light circuit 1 to drive the liquid crystal panel 3 which creates an illumination in accordance with the intensity of the light beam of ambient environment. Therefore, an optimal viewing effect and power-saving effect can be achieved.

The control operation of the above circuit structure is as follows:

In the case of stronger light beam of the environment, the resistance of the photosensitive resistor R1 is reduced and the divided voltage input from the resistor R2 to the A/D converter U1 is increased. The A/D converter U1 outputs signals to the CPU U2. The inbuilt operation system of the CPU U2 controls the liquid crystal back light circuit 1 to increase the brightness of the back light or front light of the liquid crystal panel 3. In the case of weaker light beam of the environment, the resistance of the photosensitive resistor R1 is increased and the divided voltage input from the resistor R2 to the A/D converter U1 is reduced. The A/D converter U1 outputs signals to the CPU U2. The inbuilt operation system of the CPU U2 controls the liquid crystal back light circuit 1 to reduce the brightness of the back light or front light of the liquid crystal panel 3.

In practice, a manual adjustment optional function can be also set in the controlling program of the operation system. When a user sets the system to the manual mode, the CPU U2 automatically cuts off the input signals of the A/D converter U1 and is free from the control of the above circuit.

The above embodiments are only used to illustrate the present invention, not intended to limit the scope thereof. Many modifications of the above embodiments can be made without departing from the spirit of the present invention.

What is claimed is:

1. Adjustment device for light source of a panel, comprising:
a photosensitive resistor serving to detect the intensity of illumination of ambient environment of an appliance and change the resistance, after the photosensitive resistor is serially connected with a resistor, a preset VCC being applied to the photosensitive resistor and a divided voltage between the photosensitive resistor and the resistor being output;
an A/D converter input end of which is connected between the photosensitive resistor and the resistor, the A/D converter serving to output controlling signals in accordance with the variation of the input voltage; and
a CPU input end of which is connected with the output end of the A/D converter, the CPU having at least one inbuilt operation system and relevant controlling program, according to the variation of the output signals of the A/D converter, the CPU serving to control a liquid crystal back light circuit to drive the liquid crystal panel which creates a displaying illumination corresponding to the intensity of the illumination of ambient environment.

2. Adjustment device for light source of a panel as claimed in claim 1, wherein a manual adjustment optional function is set in the controlling program of the operation system, whereby when a user sets the system to the manual mode, the CPU automatically cuts off the control of the A/D converter.

3. Adjustment device for light source of a panel as claimed in claim 1, wherein the photosensitive resistor is inlaid in the surface of a housing on the same side as the liquid crystal panel.
